(19) United States
(12) Patent Application Publication
(10) Pub. No.: US 2026/0120191 A1
(43) Pub. Date: Apr. 30, 2026

(54) SYSTEMS AND METHODS FOR MACHINE LEARNING-BASED DIGITAL CLAIM ASSESSMENT, AUTOMATED ERROR IDENTIFICATION, AND AUTOMATED REMEDIATION PREDICTION FOR AND CORRECTING DEFECTIVE DATA RECORDS IN A COMPUTING ENVIRONMENT

(71) Applicant: Technology Partners LLC d/b/a ImagineSoftware, Charlotte, NC (US)

(72) Inventor: Sam Faris Khashman, Charlotte, NC (US)

(73) Assignee: Technology Partners LLC d/b/a ImagineSoftware, Charlotte, NC (US)

(21) Appl. No.: 19/005,720

(22) Filed: Dec. 30, 2024

Related U.S. Application Data
(60) Provisional application No. 63/615,642, filed on Dec. 28, 2023.

(51) Int. Cl. G06Q 40/08

(52) U.S. Cl. CPC G06Q 40/08

(57) ABSTRACT

A system and method for automated defective data record resolution is disclosed. The method is performed by a remote digital claim remediation service operating within a distributed network of computers. The method includes receiving adverse digital claim data comprising a plurality of data fields, where at least one data field contributes to an adverse action against a target digital claim. A feature extraction model processes the claim data to extract defect feature data. A machine learning model then computes defect inferences, identifying likely defect types and associated confidence values. The method further evaluates these inferences against predefined routing criteria, routing the claim data either to a remediation or disposal queue. For remediable claims, a machine learning model generates remediation inferences, which are applied to adapt and correct the claim. The defect-free claim is then resubmitted in real-time or near real-time, accelerating claim processing and enhancing system efficiency.

### CROSS-REFERENCE TO RELATED APPLICATIONS

This application claims the benefit of U.S. Provisional Application No. 63/615,642, filed 28 Dec. 2023, which is incorporated in its entirety by this reference.

### TECHNICAL FIELD

This invention relates generally to the computer-based learning field and, more specifically, to new and useful systems and methods that utilize machine learning to accelerate an adaptation or remediation of anomalous digital claims.

### BACKGROUND

In large-scale digital systems, the processing and handling of digital claim data, including identifying discrepancies or anomalies, often involve complex assessments. Historically, these assessments have been performed through manual processes that rely on domain-specific knowledge to analyze claim attributes, extract relevant features, and classify claim status. However, such methods are resource-intensive, time-consuming, and difficult to scale, particularly in environments where substantial volumes (e.g., thousands) of digital claims require analysis and routing.

Current systems lack efficient mechanisms to automatically assess digital claims, generate explainable outcomes, and route claims for further processing based on probabilistic or feature-based inferences. Existing approaches fail to leverage advanced computational techniques, such as machine learning models, to extract patterns from historical claim data and generate accurate predictions about claim handling outcomes.

Accordingly, there is a need for a technical solution that implements machine learning-based feature extraction, inference generation, and conditional routing of digital claim data within a computing environment. Such solutions can reduce latency, optimize resource allocation, and enable scalable claim processing operations while providing explainable outcomes to downstream systems.

The embodiments of the present application address the above-described technical challenges by integrating machine learning algorithms, data processing pipelines, and automated decision-making subsystems to streamline the handling, analysis, and routing of digital claim data.

### BRIEF SUMMARY OF THE EMBODIMENTS OF THE PRESENT APPLICATION

In some embodiments, a computer-implemented system for automated data record resolution includes a distributed computing network comprising a plurality of interconnected computers configured to execute a digital claim remediation service. The system further includes a data input module configured to receive, via the distributed computing network, adverse digital claim data comprising a plurality of data fields, wherein at least one data field of the plurality of data fields includes data contributing to a cause of an adverse action against a target digital claim. The system includes a feature extraction module, implemented by one or more processors, configured to extract defect feature data from at least one or more of the plurality of data fields of the adverse digital claim data. The system further includes a digital claim defect prediction machine learning model, executed by the one or more processors, configured to compute one or more digital claim defect inferences based on an input of at least the defect feature data, wherein each of the one or more digital claim defect inferences includes a likely digital claim defect type and a confidence value for the likely digital claim defect type. The system also includes a routing decision module, executed by the one or more processors, configured to automatically evaluate one or more of the likely claim defect type and the confidence value against predefined digital claim routing criteria stored in memory. When the likely claim defect type and confidence value satisfy the predefined digital claim routing criteria, the routing decision module routes the adverse digital claim data to an automated claim remediation module or queue. When the likely claim defect type and confidence value fail to satisfy the predefined digital claim routing criteria, the routing decision module routes the adverse digital claim data to an automated claim disposal module or queue. The automated claim remediation module may be configured to automatically remediate one or more defects of the target digital claim and cause an automated resubmission, in real-time or near real-time, of a defect-free digital claim to accelerate processing of the adverse digital claim data. The automated claim disposal module may be configured to block resubmission of the target digital claim or a variation of the target digital claim to preserve computational resources of the system.

In some embodiments, the automated claim remediation module further includes a digital claim remediation machine learning model, executed by the one or more processors of the automated claim remediation module, configured to automatically generate one or more digital claim remediation inferences for correcting one or more defects of the target digital claim based on an input of the one or more digital claim defect inferences. Each digital claim remediation inference includes a target digital claim parameter requiring correction in the target digital claim and a likely parameter value for establishing the correction in the target digital claim.

In some embodiments, the automated claim remediation module may be further configured to adapt the target digital claim by automatically applying the likely parameter value to the target digital claim parameter. The application of the likely parameter value either replaces a pre-existing defective parameter value or fills one or more parameter fields that were missing a given parameter value, thereby constructing the defect-free digital claim.

In some embodiments, the system further includes a feature extraction module configured to extract defect feature data from at least one or more of the plurality of data fields of the adverse digital claim data. The feature extraction module comprises a natural language processing (NLP) module configured to tokenize, vectorize, and generate semantic embeddings for textual data fields within the adverse digital claim data to identify defect features. The system further comprises a training module, executed by the one or more processors, configured to train the digital claim defect prediction machine learning model using a training dataset comprising historical digital claim data annotated with corresponding defect types and outcomes. The system also includes a module for dynamically updating, by the one or more processors, the predefined digital claim routing criteria stored in memory based on performance metrics of previously remediated digital claims.

In some embodiments, the system further comprises a graphical user interface, wherein the graphical user interface may be configured to generate a visual representation of the likely digital claim defect type, the confidence value, and the predefined routing criteria, thereby enabling manual intervention for claims requiring human review. The automated claim remediation module may be further configured to generate the digital claim remediation inference using an ensemble of machine learning models, wherein the ensemble comprises at least a supervised learning model and a reinforcement learning model to optimize remediation accuracy. The automated claim disposal module or queue may be further configured to trigger, by the one or more computer processors, an automated notification to an external system or user, wherein the notification indicates the adverse digital claim's unresolvable status and includes metadata for further action. In response to constructing the defect-free digital claim, the system may be further configured to automatically route the defect-free digital claim to a resubmission or a submission portal, and automatically resubmit the defect-free digital claim via the resubmission or submission portal. The system further comprises an explainability module, executed by the one or more computer processors, configured to apply to the digital claim defect prediction machine learning model and generate interpretability scores for each defect inference, wherein the interpretability scores indicate the contribution of individual defect features to the prediction.

In some embodiments, the system further includes an adverse claim decoder, executed by the one or more computer processors, configured to generate one or more adverse action rationales comprising an explanation of a reason for an adverse action against the target digital claim.

In some embodiments, the system may be further configured to associate the one or more adverse action rationales with the adverse digital claim data and surface the associated adverse action rationales via a graphical user interface, based on a selection of the adverse digital claim data from an automated claim disposal queue.

In some embodiments, the predefined routing criteria include at least a minimum confidence threshold value and a classification of the defect type as remediable or non-remediable. The system further comprises a routing decision module that automatically evaluates the defect type and confidence value against the predefined routing criteria to ensure the proper disposition of adverse digital claim data.

In some embodiments, the feature extraction module further includes an NLP-based component capable of extracting semantic insights from unstructured textual data fields within the adverse digital claim data.

In some embodiments, the explainability module may be further configured to generate interpretability metrics, which assess the relative contribution of specific feature data to the defect prediction model's output, thereby providing enhanced transparency to system users.

In some embodiments, the automated claim disposal module or queue further supports integration with external data pipelines, ensuring seamless synchronization with downstream claim processing systems and enabling robust scalability of the system's remediation capabilities.

### BRIEF DESCRIPTION OF THE FIGURES

FIG. 1 illustrates a schematic representation of a system 100 in accordance with one or more embodiments of the present application;

FIG. 1A illustrates a schematic representation of a subsystem of the system 100 in accordance with one or more embodiments of the present application;

FIG. 2 illustrates an example method 200 in accordance with one or more embodiments of the present application;

FIG. 3 illustrates an example schematic of using a machine learning-based claim denial decoder and a machine learning-based claim fix identifier in accordance with one or more embodiments of the present application;

FIG. 4 illustrates an example of a claim remediation graphical user interface in accordance with one or more embodiments of the present application;

FIG. 5 illustrates an example of a claim remediation graphical user interface in accordance with one or more embodiments of the present application; and

FIG. 6 illustrates an example of using a claim denial prediction machine learning model, a machine learning-based claim denial decoder, and a machine learning-based claim fix identifier in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Clinical Note Data Classification and Machine Learning Inference(s)-Informed Automated Routing of Electronic Communications

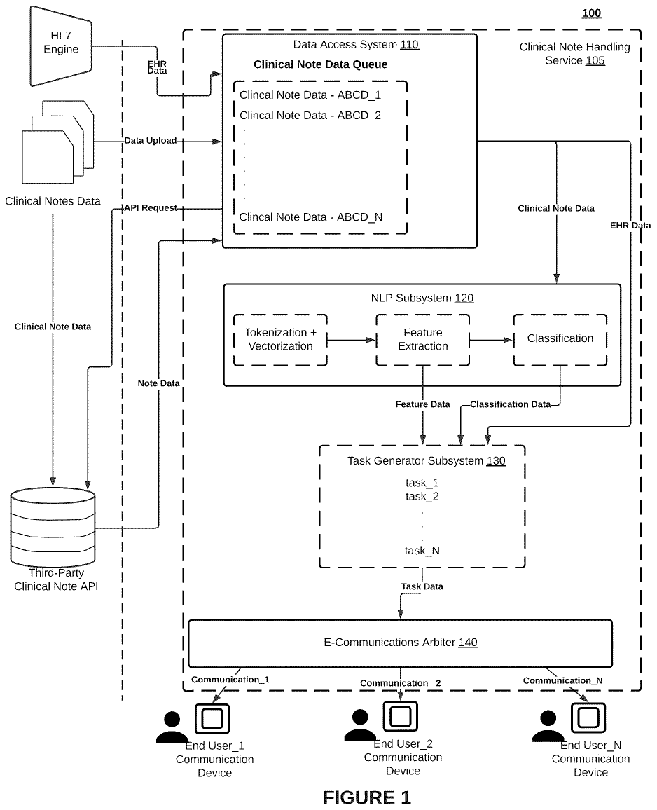

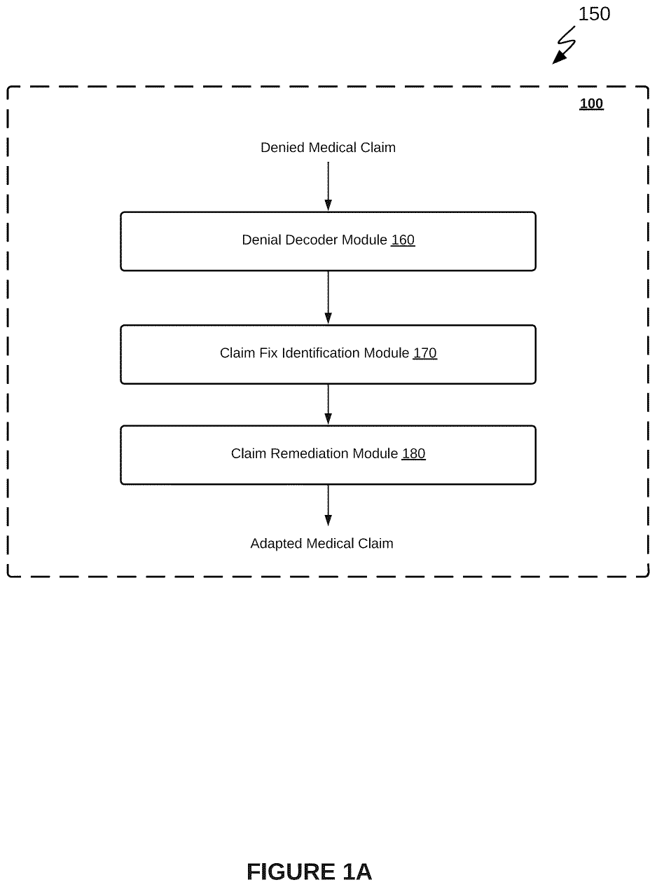

As shown in FIG. 1, a system 100 that implements clinical note data classification and uses machine learning inferences to inform an automated routing of electronic communications includes a clinical note data access and intake subsystem 110, feature extraction and classification subsystem 120, automated task generation subsystem 130, and an electronic communications subsystem 140.

### 1.05 Clinical Note Data Handling and Automated Electronic Communications Service

The clinical note data handling and automated electronic communications service 105 implementing the system 100, sometimes referred to herein as the “clinical note handling service 105” may be implemented by a distributed network of computers (e.g., hosted on the cloud, etc.) and may be in operable and control communication with each of the subsystems of the system 100 and/or third-party subsystems and services. That is, the clinical note handling service 105 may include a centralized controlling computer server(s) and associated computing systems that encourages and/or controls the intelligent and accelerated clinical note data handling, clinical note data classification, and clinical note data-informed communications routing operations of each of the subsystems, described herein, (e.g., subsystems 110-140).

In one or more embodiments, the distributed computing network may be configured to support the execution of the digital claim remediation service by facilitating scalable and efficient processing of adverse digital claim data. The distributed computing network comprises a plurality of interconnected computers that are deployed to execute various modules of the digital claim remediation service, including the data input module, the feature extraction module, the digital claim defect prediction machine learning model, the routing decision module, the automated claim remediation module, the automated claim disposal module, and the machine learning-based adverse claim decoder. The distributed computing network ensures that high volumes of adverse digital claim data are processed in real-time or near real-time, minimizing latency and maximizing throughput.

The distributed computing network enables parallel processing of multiple adverse digital claim datasets by allocating computational tasks across multiple nodes within the network. Each node within the distributed computing network executes specific processing steps, such as extracting defect feature data, computing defect inferences, or applying remediation inferences, thereby ensuring efficient utilization of computational resources. The distributed computing network may be further configured to dynamically allocate resources based on workload demands, allowing the system to scale in response to varying volumes of adverse digital claim data.

The distributed computing network supports robust fault tolerance to maintain operational reliability. Redundant nodes and automated failover mechanisms ensure that the distributed computing network continues processing adverse digital claim data even in the event of hardware or software failures. The distributed computing network includes monitoring systems to detect and resolve potential performance issues, ensuring consistent processing capabilities and high availability.

The distributed computing network integrates with the graphical user interface to provide real-time updates and feedback to users. The distributed computing network synchronizes processed data and configuration changes with the graphical user interface, ensuring that displayed information accurately reflects the current state of the digital claim remediation service. The distributed computing network enables users to interact with the system seamlessly, regardless of the volume or complexity of adverse digital claim data being processed.

The distributed computing network supports secure data handling by implementing encryption protocols for data transmission and access control mechanisms for user authentication. Sensitive claim data transmitted and processed within the distributed computing network may be protected against unauthorized access or interception, ensuring compliance with industry standards and regulatory requirements.

The distributed computing network may be designed to accommodate diverse deployment environments, including on-premise, cloud-based, or hybrid architectures. Configurable parameters within the distributed computing network enable adaptation to specific infrastructure constraints or organizational requirements. The distributed computing network ensures flexibility and scalability for various applications and industries, including healthcare, insurance, and financial services.

The distributed computing network enhances the overall performance of the digital claim remediation service by enabling efficient processing, resource optimization, and seamless integration with other system components. The distributed computing network ensures that the digital claim remediation service can operate effectively under high workloads, providing reliable and scalable solutions for automated data record resolution.

### 1.1 Clinical Note Data Access+Intake Subsystem

The clinical note data access and intake subsystem 110, which may be sometimes referred to herein as the “data access system” 110, preferably functions to enable one or more electronic connections between the system 100 and one or more external systems of one or more subscribers to the clinical note handling service 105. The data access subsystem 110 may include one or more access modules that may function to establish or create content communication channels, which are sometimes referred to as “data handling nexus”, between the system 100 and systems associated with subscribers to the service 105. In one or more embodiments, the data handling nexus may include any suitable medium and/or method of transmitting digital items between at least two devices including, but not limited to, a service bus, a digital communication channel or line, and/or the like.

Additionally, or alternatively, the clinical note data access and intake subsystem 110 may provide a web-based graphical user interface or web application that may enable one or more subscribers to upload clinical note data (e.g., clinical note CSV files, and/or the like) directly into the system 100.

In one or more embodiments, based on accessing or receiving clinical note data, the data access system 110 may function to store the clinical note data in a queue and preferably generate and/or associate identifying metadata including, but not limited to, a session identifier providing a unique identification value for a clinical session associated with a target clinical note, a patient identifier, a doctor identifier, a clinical note identifier, and/or the like. In such embodiments, the identifying metadata may be passed along with the clinical note data to one or more downstream subsystems (e.g., subsystem 120, subsystem 130, subsystem 140) to enable processing, tracking, account identification, and/or the like.

In one or more embodiments, the clinical note data handling service 105 may function to implement a clinical note data handling application programming interface (API) that enables programmatic communication, access, and control between the system 100 and the one or more sub-services within the system 100 and one or more (third-party) APIs associated with one or more subscribers to the clinical note data handling service 105.

Additionally, or alternatively, the data access system 110 may receive the clinical notes data via a health level seven (HL7) interface. In such embodiments, an electronic health record (EHR) system associated with a subscriber may periodically or in real-time send one or more HL7 messages comprising clinical note data and/or other types of electronic health record (EHR) data to the data access system 110. In turn, the data access system 110 may receive the one or more HL7 messages via a secure channel (e.g., port) of the clinical note handling service 105 and provide the one or more HL7 messages to the NLP subsystem 120.

### 1.2 NLP: Feature Identification+Extraction and Classification Subsystem

The feature extraction and classification subsystem 120, which may sometimes be referred to herein as a “NLP subsystem”, preferably functions to perform various natural language processing tasks including extracting features from clinical note data and computing one or more classification inferences and/or labels for each clinical note file being handled by the clinical note data handling service 105. The NLP subsystem 120 may additionally include one or more text processing modules and/or machine learning models that may tokenize textual data within a clinical note and vectorize and/or generate embeddings for each set of tokens and further cluster the tokens into semantically-related token groups or the like.

In one or more embodiments, the NLP subsystem 120 includes a machine learning module or subsystem that may be intelligently configured to predict various classifications for each clinical note document including, but not limited to, identifying whether a clinical note has a clinical recommendation, a number of clinical recommendations in a given clinical note, a type of clinical recommendation, a strength of a clinical recommendation, an urgency of a clinical recommendation, and/or the like. In such embodiments, the NLP subsystem 120 may include a plurality of distinct machine learning-based classification submodules, which may be outlined herein below in the method 200.

Additionally, or alternatively, in some embodiments, the NLP subsystem 120 may include extensible feature extraction and classification heuristics that may be applied alone or in combination with one or more machine learning-based classifiers described herein.

Additionally, or alternatively, the NLP subsystem 120 may implement one or more ensembles of pre-trained or trained machine learning models. The one or more ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation form transformers (BERT) for masked language model tasks and next sentence prediction tasks and the like, variations of BERT (i.e., ULMFIT, XLM UDify, MT-DNN, SpanBERT, ROBERTa, XLNet, ERNIE, KnowBERT, VideoBERT, ERNIE BERT-wwm, MobileBERT, TinyBERT, GPT, GPT-2, GPT-3, GPT-4, GPT-40 (and all subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein.

Additionally, or alternatively, system 100 (or service) may implement a training module (not shown) training module, executed by one or more processors, may be configured to train machine learning models utilized within the digital claim remediation service, including the digital claim defect prediction machine learning model, the digital claim remediation machine learning model, and the machine learning-based adverse claim decoder. The training module processes training datasets that comprise historical claim data annotated with defect types, remediation outcomes, and adverse action rationales to optimize the performance of the machine learning models. The training module ensures that the machine learning models accurately identify defect types, generate remediation inferences, and produce adverse action rationales.

The training module applies supervised learning techniques to train the machine learning models. The training module processes training datasets by extracting relevant features, normalizing input data, and mapping defect types to corresponding resolutions. The training module utilizes gradient-based optimization algorithms to adjust model parameters and minimize prediction errors during the training process. For example, the training module may train the digital claim defect prediction machine learning model to identify missing or incorrect data fields within adverse digital claim data and assign confidence values to defect inferences.

The training module incorporates mechanisms for continuous learning to ensure that the machine learning models remain adaptable to evolving patterns in adverse digital claim data. Continuous learning may be achieved by retraining the machine learning models using new data generated during system operations, including user corrections and feedback. The training module processes the additional data to refine the machine learning models, improving accuracy and responsiveness to new defect types or claim scenarios.

The training module supports the generation of synthetic training data to augment existing datasets. The training module uses data augmentation techniques, such as introducing controlled variations in input data fields, to expand the diversity of training datasets. This capability ensures that the machine learning models are robust to variations in adverse digital claim data and can generalize effectively across different claim types and industries.

The training module operates within the distributed computing network to process large training datasets efficiently. The distributed computing network enables the training module to parallelize computational tasks, such as feature extraction, model parameter updates, and validation, across multiple nodes. The training module utilizes the distributed computing network to reduce training times and accommodate high-dimensional data associated with adverse digital claim processing.

The training module includes configurable parameters that allow users to customize training processes to specific operational requirements. Users can adjust the frequency of model retraining, define thresholds for performance metrics, and select specific subsets of training data to prioritize during model updates. The training module integrates with a graphical user interface, allowing users to monitor training progress, review model performance metrics, and manage training configurations.

The training module ensures that the machine learning models within the digital claim remediation service maintain high levels of accuracy, scalability, and adaptability. The training module supports the effective implementation of machine learning-based solutions for defect identification, remediation, and adverse action rationales, contributing to the overall performance and reliability of the digital claim remediation service.

Additionally, or alternatively, a feature extraction module of NLP subsystem 120, implemented by one or more processors, specifically programmed to process adverse digital claim data comprising a plurality of data fields. Each data field within the adverse digital claim data may be analyzed to extract defect feature data that may contribute to a cause of an adverse action against a target digital claim. The feature extraction module utilizes advanced processing techniques, including natural language processing operations, to tokenize textual data fields, vectorize the tokenized data, and generate semantic embeddings. These semantic embeddings provide a structured representation of the textual data fields, enabling the identification of defect feature data that is otherwise difficult to detect through traditional methods.

The feature extraction module may be further configured to identify specific defect feature data within the adverse digital claim data. For example, the feature extraction module may detect missing information, such as omitted policy numbers or authorization codes, mismatched fields, such as incorrect procedure codes or modifiers, or invalid entries, such as improper date formats. The extracted defect feature data may be outputted as structured data that can be utilized as input to a digital claim defect prediction machine learning model. This structured output ensures consistency and compatibility for subsequent processing steps within the digital claim remediation service.

The feature extraction module operates in conjunction with a distributed computing network to achieve scalable and efficient processing of adverse digital claim data. The distributed computing network allows the feature extraction module to handle high volumes of claim data in real-time or near real-time, accommodating dynamic variations in claim submissions. The distributed computing network further facilitates parallel processing of data fields within multiple adverse digital claims, ensuring efficient extraction of defect feature data even under heavy workloads.

The feature extraction module may also utilize customizable configuration settings to adapt to specific types of adverse digital claim data. The settings of the feature extraction module may include adjustable parameters for the level of detail in the semantic embeddings, thresholds for identifying potential defect feature data, and predefined mappings to normalize inconsistencies across different formats of adverse digital claim data. The customizable nature of the feature extraction module ensures applicability across a wide range of digital claim types and industries.

### 1.3 Automated Recommendation Task Generator

The automated recommendation handling task and instructions generator 130, which may be sometimes referred to herein as a “tasks generator” 130 or “automated task generation subsystem” 130, preferably functions to automatically generate a clinical recommendation registry including one or more tasks and/or one or more instructions for handling and/or disposing of clinical recommendations identified within a clinical note. In one or more embodiments, the task generator 130 may take in as input a set of extracted features and a set of classification inferences computed by the NLP subsystem 120 to compose and/or structure a given registry. It shall be noted that, in some portions of the disclosure, a “clinical recommendation registry” may be referred to as a “clinical recommendation worklist” or the like.

A given clinical recommendation registry preferably includes an enumeration of tasks and/or computer-executable instructions that may be automatically executed by the clinical note handling service 105. Additionally, or alternatively, the clinical recommendation registry may include patient session identifier (ID) data, clinical recommendation ID data, patient communications account data (e.g., email, phone number, messaging ID, etc.) that may be used as input in structuring one or more electronic communications to a given patient, as described herein and using at least e-communications arbiter 140.

Furthermore, in some embodiments, the task generator 130 may also be capable of ingesting additional electronic health record (EHR) data, such as appointment data, discharge data, transfer data, prescription data, and/or the like. This additional data may inform one or more operations of the task generator 130 and/or may be directly or indirectly provided as input to the e-communications arbiter 140 for structuring electronic communications to a given patient or other end users (e.g., a referring doctor, care team, etc.).

### 1.4 Automated E-communications Arbiter & Routing

The electronic communications subsystem 140, which may be sometimes referred to herein as an “e-communications arbiter” 140, preferably functions to take in as input a clinical recommendation registry associated with a target clinical recommendation and structure, as output, an automated electronic communication scheme for handling and/or disposing of the target clinical recommendation. Accordingly, the e-communications arbiter 140 may function to intelligently select an optimal communication channel for communicating with an end user or patient, structuring communication parameters, such as a communication schedule and/or communication frequency and composing message content for each communication to the end user. In one or more embodiments, the e-communication arbiter may function to employ a selection matrix or the like for selecting a most optimal communication channel and may further employ pre-trained language models and/or messaging templates to compose messaging content for a given communication.

### 1.5 Automated or Semi-automated Claim Adaptation

As shown in FIG. 1A, a subsystem 150 (of the system 100) for intelligent adaptation of an adverse digital claim may include a denial decoder module 160, a claim fix identification module 170, and a claim remediation module 180. It shall be noted that the subsystem 150 may operate independently of the clinical note handling service 105 or in conjunction with the clinical note handling service 105.

The denial decoder module 160, which may sometimes be referred to herein as “machine learning-based adverse claim decoder”, may function to receive an adverse digital claim and output an explainable rationale that indicates why the adverse digital claim was rejected by a target entity. Stated differently, the output of the denial decoder module 160 may be designed to provide a more detailed explanation than the generic and vague explanations provided by insurance entities, which may enable more effective and targeted claim remediation efforts.

Additionally, or alternatively, machine learning-based adverse claim decoder, executed by one or more processors, may be configured to generate adverse action rationales for adverse digital claim data. The machine learning-based adverse claim decoder analyzes defect feature data and other contextual data associated with adverse digital claim data to produce explanations of reasons for adverse actions against a target digital claim. The adverse action rationales include detailed descriptions of defect types, identified inconsistencies, and potential causes that contribute to claim denials or rejections.

The machine learning-based adverse claim decoder utilizes a trained machine learning model that may be optimized for generating interpretable outputs. The machine learning-based adverse claim decoder incorporates natural language generation algorithms to produce human-readable explanations. For example, the machine learning-based adverse claim decoder may identify a missing authorization number as a defect and generate an adverse action rationale that states, “The claim was denied due to the absence of a required authorization number.”

The machine learning-based adverse claim decoder dynamically generates adverse action rationales by processing structured and unstructured data fields within adverse digital claim data. The machine learning-based adverse claim decoder integrates with the feature extraction module to receive processed defect feature data and applies advanced inference algorithms to detect patterns indicative of adverse actions. The machine learning-based adverse claim decoder outputs adverse action rationales as structured or textual data that can be stored, displayed, or transmitted to external systems.

The machine learning-based adverse claim decoder operates within a distributed computing network to handle high volumes of adverse digital claim data efficiently. The distributed computing network enables the machine learning-based adverse claim decoder to process multiple claims in parallel, ensuring scalability and minimizing latency. The machine learning-based adverse claim decoder supports continuous updates to its training model, incorporating new data and feedback to improve accuracy and adaptability over time.

The machine learning-based adverse claim decoder integrates with graphical user interfaces to provide visibility into generated adverse action rationales. The graphical user interface associated with the machine learning-based adverse claim decoder displays adverse action rationales alongside corresponding adverse digital claim data, enabling users to review and verify outputs. The graphical user interface may include features such as filters for categorizing adverse action rationales, visual indicators for defect types, and options for manual input or overrides.

The machine learning-based adverse claim decoder enhances the transparency and interpretability of the digital claim remediation service by providing clear and detailed explanations for adverse actions. The machine learning-based adverse claim decoder ensures that users and external systems can understand and address the underlying reasons for claim denials or rejections, contributing to more informed decision-making and streamlined workflows. The machine learning-based adverse claim decoder further supports integration with external claim management systems to transmit adverse action rationales as part of claim processing pipelines, ensuring seamless interoperability and traceability.

In one or more embodiments, denial decoder module 160 implements an explainability module, implemented by one or more processors, which may be configured to enhance the transparency and interpretability of machine learning models within the digital claim remediation service. The explainability module generates interpretability scores and detailed explanations for outputs produced by machine learning models, including the digital claim defect prediction machine learning model, the digital claim remediation machine learning model, and the machine learning-based adverse claim decoder. The explainability module ensures that users and systems can understand the rationale behind predictions, inferences, and decisions made by the machine learning models.

The explainability module computes interpretability scores that quantify the contribution of individual features to a specific prediction or inference. The explainability module applies algorithms such as SHAP (Shapley Additive Explanations), LIME (Local Interpretable Model-Agnostic Explanations), or other feature attribution techniques to calculate the relative importance of defect feature data and other input parameters. For example, the explainability module may determine that a missing diagnosis code contributed 70% to the likelihood of a claim defect inference.

The explainability module generates textual explanations to accompany interpretability scores. Textual explanations provide human-readable insights into the decision-making process of machine learning models. For instance, the explainability module may produce an explanation stating, “The defect inference was primarily influenced by an invalid procedure code and a missing policy number, which together accounted for 85% of the prediction.”

The explainability module integrates with graphical user interfaces to display interpretability scores and textual explanations alongside corresponding adverse digital claim data. The graphical user interface associated with the explainability module includes interactive visualizations, such as bar charts or heatmaps, to represent feature contributions. Users can explore detailed breakdowns of individual defect feature data and associated interpretability metrics through the graphical user interface, enabling a deeper understanding of machine learning outputs.

The explainability module supports customizable configurations to adapt interpretability outputs to specific operational requirements. Configurable parameters include thresholds for displaying interpretability scores, selection of feature attribution algorithms, and formatting options for textual explanations. Customizable configurations ensure that the explainability module aligns with user preferences and organizational policies.

The explainability module operates within the distributed computing network to process interpretability computations efficiently. The distributed computing network facilitates parallel processing of interpretability tasks, ensuring scalability and responsiveness in generating explanations for high volumes of claim data. The distributed computing network also ensures that interpretability metrics are synchronized with other components of the digital claim remediation service, such as the feedback module and routing decision module.

The explainability module enhances the usability and reliability of the digital claim remediation service by providing transparency into machine learning processes. The explainability module fosters trust in automated systems by enabling users to verify and validate the reasoning behind defect inferences, remediation suggestions, and adverse action rationales. The explainability module ensures compliance with regulatory requirements for explainable artificial intelligence and supports informed decision-making across various applications and industries.

Additionally, or alternatively, subsystem 150 may include a routing decision module (not shown), which may be executed by one or more processors, may be configured to evaluate one or more of a likely digital claim defect type and a confidence value against predefined digital claim routing criteria stored in memory. The routing decision module determines whether adverse digital claim data should be routed to an automated claim remediation module or an automated claim disposal module based on the evaluation. The predefined digital claim routing criteria include a combination of thresholds and rules that specify acceptable ranges for confidence values and classifications of defect types as remediable or non-remediable.

The routing decision module processes the likely digital claim defect type and confidence value by comparing each against the predefined digital claim routing criteria. For example, when the confidence value associated with a likely digital claim defect type exceeds a minimum confidence threshold and the defect type may be classified as remediable, the routing decision module routes the adverse digital claim data to the automated claim remediation module or queue. Alternatively, when the confidence value falls below the minimum confidence threshold or the defect type may be classified as non-remediable, the routing decision module routes the adverse digital claim data to the automated claim disposal module or queue.

The routing decision module supports dynamic updates to the predefined digital claim routing criteria to adapt to changing requirements or data patterns. Updates to the predefined digital claim routing criteria may be performed based on performance metrics of previously processed claims or user-defined parameters. The dynamic update capability ensures that the routing decision module maintains optimal decision-making performance and adapts to the evolving nature of adverse digital claim data.

The routing decision module operates within a distributed computing network to handle large volumes of adverse digital claim data efficiently. The distributed computing network enables the routing decision module to process multiple claims in parallel, ensuring scalability and minimizing processing delays. The routing decision module may be further configured to support integration with other system components, including the automated claim remediation module, the automated claim disposal module, and graphical user interfaces, to facilitate seamless data processing workflows.

The routing decision module provides enhanced configurability by allowing users to adjust predefined digital claim routing criteria through a graphical user interface. The graphical user interface may include features such as sliders to set confidence thresholds, drop-down menus to classify defect types, and visual indicators to display claim routing outcomes. The enhanced configurability ensures that the routing decision module can be tailored to meet the specific needs of various applications and industries.

The digital claim fix identification module 170 may function to receive an adverse digital claim and/or the output of the denial (adverse action) decoder module 160 and output a set of proposed modifications or adjustments that, when implemented, likely converts the adverse digital claim to an approved digital claim. The digital claim fix identification module 170 may utilize machine learning techniques and/or advanced analytics to systematically evaluate the reasons for claim denial and propose specific changes that can rectify the adverse digital claim.

The claim remediation module 180, which may sometimes be referred to herein as “automated claim remediation module”, may function to automatically or semi-automatically adapt the adverse digital claim based on the output of the claim fix identification module 170. The claim remediation module 180 may be designed to streamline the claim remediation process by applying the recommended modifications or adjustments to the adverse digital claim with the objective of converting it into an approved claim upon resubmission. For example, in the fully automated mode, the claim remediation module 180 may autonomously implement the proposed claim modifications. In another example, in the semi-automated mode, the claim remediation module 180 may surface, via a claim remediation graphical user interface, the recommended modifications in which a user can select a button or any suitable graphical user interface object to implement the suggested changes (i.e., the claim remediation graphical user interface may be designed to clearly display the adverse digital claim alongside the proposed modifications, allowing the user to review and understand the rationale behind each suggestion).

Additionally, or alternatively, the graphical user interface, implemented as part of the digital claim remediation service, may be configured to provide interactive tools for visualizing, managing, and adjusting parameters associated with adverse digital claim data and corresponding system processes. The graphical user interface enables users to view and interact with adverse digital claim data, defect feature data, confidence values, routing decisions, remediation inferences, and adverse action rationales. The graphical user interface enhances usability by providing an intuitive platform for configuring system operations and reviewing outputs.

The graphical user interface displays adverse digital claim data, including a plurality of data fields and corresponding defect feature data identified by the feature extraction module. The graphical user interface further includes visual indicators that highlight specific defect feature data contributing to adverse actions. For example, the graphical user interface may use color coding or icons to flag missing fields, invalid entries, or mismatched data elements within adverse digital claim data.

The graphical user interface provides tools for adjusting predefined digital claim routing criteria. Adjustable parameters, such as confidence thresholds and defect type classifications, are accessible through dynamic sliders, drop-down menus, and input fields. The graphical user interface allows users to configure thresholds for routing decisions, ensuring that the digital claim remediation service aligns with specific operational requirements. For instance, the graphical user interface may include a slider to set the minimum confidence threshold for routing claims to an automated claim remediation module.

The graphical user interface integrates features for reviewing and validating digital claim remediation inferences generated by the automated claim remediation module. Users can view target digital claim parameters, likely parameter values, and applied corrections within the graphical user interface. The graphical user interface supports manual overrides, enabling users to modify or approve remediation inferences before resubmission of defect-free digital claim data. The graphical user interface may also include a summary view that displays a list of remediated claims, associated defect types, and confidence values.

The graphical user interface incorporates functionality for reviewing adverse action rationales generated by the machine learning-based adverse claim decoder. Adverse action rationales are displayed alongside corresponding adverse digital claim data, providing users with detailed explanations of reasons for claim denials or rejections. The graphical user interface supports filtering and categorization of adverse action rationales, enabling efficient navigation and review of claim data.

The graphical user interface operates in conjunction with the distributed computing network to ensure real-time updates and interactions. The distributed computing network facilitates rapid synchronization between the graphical user interface and backend processing components, ensuring that displayed data and configurations reflect the current state of the digital claim remediation service. The graphical user interface supports user authentication and access controls, ensuring secure interactions with sensitive claim data.

The graphical user interface provides detailed customization options to accommodate diverse industry needs. Users can configure execution frequencies for machine learning models, define specific time windows for processing claims, and set advanced parameters for adaptive learning mechanisms. The graphical user interface enhances operational efficiency by enabling precise control over system processes and providing comprehensive visibility into claim data workflows. The graphical user interface ensures that users can effectively manage and optimize the digital claim remediation service for a wide range of applications and environments.

Additionally, or alternatively, the automated claim remediation module, implemented by one or more processors, may be configured to remediate defects in adverse digital claim data by generating one or more digital claim remediation inferences and applying the generated remediation inferences to the adverse digital claim data. The automated claim remediation module utilizes a digital claim remediation machine learning model to analyze defect feature data and compute digital claim remediation inferences for correcting defects identified in adverse digital claim data. Each digital claim remediation inference includes a target digital claim parameter requiring correction and a likely parameter value for establishing the correction in the target digital claim.

The automated claim remediation module operates by applying the likely parameter value to the target digital claim parameter identified within the adverse digital claim data. The application of the likely parameter value replaces a pre-existing defective parameter value or populates a previously missing parameter field, thereby constructing defect-free digital claim data. For example, the automated claim remediation module may replace an invalid policy number with a corrected value or populate an empty field with a required diagnosis code.

The automated claim remediation module performs real-time or near real-time remediation of adverse digital claim data, enabling rapid adaptation of digital claims and acceleration of claim processing workflows. The automated claim remediation module integrates with a routing decision module to receive adverse digital claim data that satisfies predefined routing criteria for remediation. Upon successful remediation, the automated claim remediation module triggers the resubmission of the defect-free digital claim data to an external claim processing system or portal.

The automated claim remediation module further includes a dynamic learning mechanism that continuously updates the digital claim remediation machine learning model. The dynamic learning mechanism incorporates new training data from successfully remediated claims and user-provided feedback to enhance the accuracy and adaptability of the digital claim remediation machine learning model. This continuous improvement process ensures that the automated claim remediation module remains effective in addressing evolving patterns of defects in digital claim data.

The automated claim remediation module operates in conjunction with a distributed computing network to ensure scalability and efficiency. The distributed computing network supports parallel processing of multiple adverse digital claim datasets, enabling the automated claim remediation module to handle high volumes of claim data without delays. Configurable parameters within the automated claim remediation module allow customization for different claim types, industries, or processing requirements, ensuring flexibility and broad applicability.

The automated claim remediation module also supports integration with graphical user interfaces to provide users with visibility into the remediation process. The graphical user interface may display visual indicators of remediated claim data, confidence levels of applied remediation inferences, and options for manual verification or overrides. The integration of the graphical user interface ensures transparency and enhances user control over the automated claim remediation process.

Additionally, or alternatively, subsystem 150 may include an automated claim disposal module (not shown), implemented by one or more processors, may be configured to handle adverse digital claim data that fails to meet predefined routing criteria for remediation. The automated claim disposal module evaluates adverse digital claim data received from a routing decision module and determines that the adverse digital claim data may be non-remediable based on confidence values, defect types, or other parameters defined in the predefined routing criteria. The automated claim disposal module routes non-remediable adverse digital claim data to a disposal queue for exclusion from further processing.

The automated claim disposal module may be further configured to preserve computational resources by blocking resubmission attempts of non-remediable adverse digital claim data or variations thereof. For example, adverse digital claim data identified as incomplete or incompatible with downstream systems may be excluded from resubmission, reducing unnecessary processing load on the distributed computing network. The automated claim disposal module includes mechanisms to record metadata associated with non-remediable adverse digital claim data, ensuring traceability and documentation for audit purposes.

The automated claim disposal module supports integration with external systems to notify relevant stakeholders of non-remediable adverse digital claim data. Notifications generated by the automated claim disposal module include metadata such as defect types, reasons for exclusion, and any associated recommendations for resolution. For example, the automated claim disposal module may notify an external claim management system of missing mandatory data fields, enabling manual review or corrective action.

The automated claim disposal module operates within a distributed computing network to ensure scalability and efficiency. The distributed computing network facilitates parallel handling of multiple adverse digital claims, enabling the automated claim disposal module to process high volumes of non-remediable claims in real-time or near real-time. The automated claim disposal module may be further configured to integrate with graphical user interfaces to provide visibility into the disposal process.

The graphical user interface associated with the automated claim disposal module displays details of adverse digital claim data routed to the disposal queue. The graphical user interface may include features such as search filters, defect type categorization, and metadata summaries, allowing users to investigate and act upon non-remediable claims as needed. The automated claim disposal module supports customizable configurations, including user-defined thresholds and rules for determining non-remediable claims, ensuring adaptability to various industry-specific requirements.

The automated claim disposal module contributes to the overall efficiency of the digital claim remediation service by streamlining the handling of non-remediable claims, preserving system resources, and providing transparency and documentation for excluded claims. The automated claim disposal module ensures that computational resources are allocated effectively and that non-remediable claims are managed in a traceable and efficient manner.

It shall be recognized that the embodiments of the present application may include additional and/or different subsystems for resolving defective digital claim data including by way of example an entity resolution subsystem or service as described in U.S. patent application Ser. No. 18/901,250, titled “Systems and Method for Automated and Assistive Resolution of Unmapped Patient Intake Data” and an adverse digital claim assessment module as described in U.S. patent application Ser. No. 18/901,279, titled “Systems and Methods for Machine Learning-Based Routing of Adverse Digital Claims, which are incorporated in their entireties by this reference.

### 2. Method for Automated or Semi-Automated Adaptation of an Adverse or a Defective Digital Claim

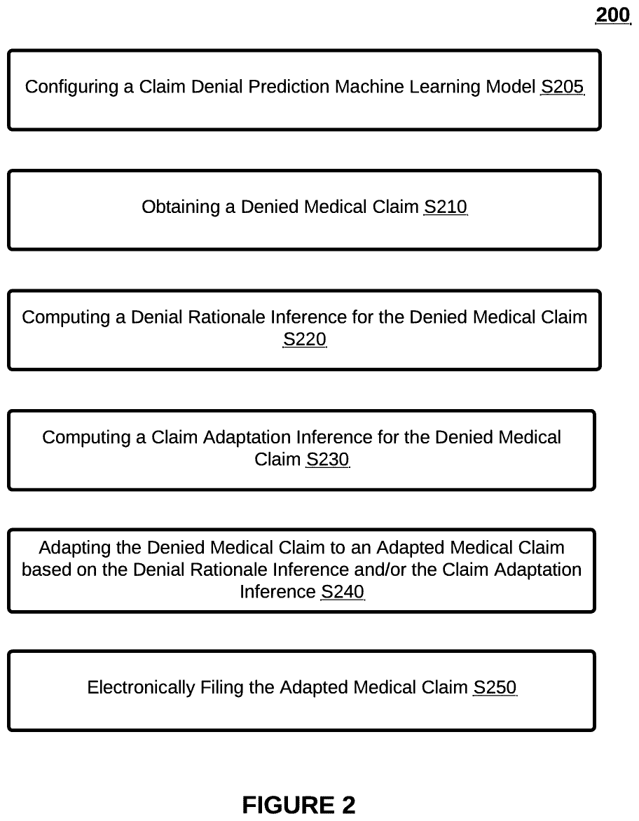

As shown in FIG. 2, the method 200 for automated or semi-automated adaptation of an adverse digital claim includes configuring a claim denial prediction machine learning model S205, obtaining an adverse digital claim S210, computing a denial rationale inference for the adverse digital claim S220, computing a claim adaptation inference for the adverse digital claim S230, adapting the adverse digital claim to an adapted digital claim based on the denial rationale inference and/or the claim adaptation inference S240, and electronically filing the adapted digital claim S250.

As will be described herein, the disclosed method addresses numerous technical challenges associated with the processing of adverse digital claim data received from external systems. Such digital claim data often suffers from inaccuracies, inconsistencies, and missing fields, which arise due to issues such as manual data entry errors, varying data standards, or incompatible data formats across systems. These deficiencies in data quality can lead to operational inefficiencies, delays in claim processing, and increased error rates if not adequately addressed. Because defects may arise in a large volume (e.g., thousands, tens of thousands, etc. of digital claims) of digital claim data, traditional manual methods for correcting such errors are resource-intensive and fail to scale effectively when processing large volumes of claim data, such as thousands or even millions of claims per day, week, or month. The disclosed method provides an automated, scalable solution that significantly reduces manual intervention and improves the accuracy and completeness of processed claim data.

One common technical problem observed in claim processing may be the inability to resolve discrepancies or defects in digital claim data, such as missing policy numbers, incorrect codes, or mismatched data entries. These technical data issues or defects can result in the data processing of a digital claim being delayed, denied, or routed incorrectly, further exacerbating inefficiencies in the system. The disclosed method utilizes machine learning-based feature extraction and defect prediction models to automatically identify and categorize claim defects. By leveraging these models, the method detects and resolves data inconsistencies, ensuring that claim data adheres to predefined standards and may be properly routed for further processing or remediation.

Another technical improvement provided by the method may be the implementation of confidence-based defect inference and routing. Machine learning models generate defect inferences accompanied by confidence scores, enabling the system to dynamically decide whether to automatically remediate claims or escalate them for manual review. For instance, claims with high-confidence defect resolutions can be automatically adapted and resubmitted, while claims with lower-confidence inferences are flagged for human intervention. This dynamic thresholding mechanism optimizes the balance between automation and accuracy, ensuring reliable claim processing while minimizing errors.

The method further addresses scalability and adaptability challenges by utilizing a distributed computing architecture. This architecture enables real-time or batch processing of claims, allowing the system to handle varying volumes of digital claim data without compromising performance. For example, during peak periods, such as after natural disasters or public health emergencies, the method can efficiently scale to process high volumes of claims without delays, ensuring timely resolutions.

The method also introduces a remediation framework that adapts defective claims by applying likely parameter values to correct errors, such as replacing missing or invalid data fields. This automated remediation process accelerates claim resolutions and reduces the need for manual adjustments. Additionally, the system incorporates a feedback loop, via a feedback module or the like, that continuously improves the accuracy and reliability of its machine learning models. By retraining models based on past resolutions and user inputs, the system becomes increasingly adept at handling new types of claim defects and discrepancies.

In one or more embodiments, the feedback module, implemented by one or more processors, may be configured to collect, process, and utilize feedback data to improve the performance and adaptability of machine learning models and operational components within the digital claim remediation service. The feedback module receives inputs from users, external systems, and automated processes, including corrections to digital claim remediation inferences, updates to adverse action rationales, and performance metrics associated with processed claims. The feedback module incorporates the collected feedback data into a continuous improvement mechanism that enhances the accuracy and efficiency of the digital claim remediation service.

The feedback module processes feedback data to identify patterns, trends, and anomalies that may impact the functionality of the digital claim remediation service. The feedback module applies statistical and analytical techniques to assess the reliability of user-provided corrections and validate updates to machine learning model outputs. For example, the feedback module may analyze user modifications to remediation inferences to determine recurring defect types and adjust the corresponding machine learning model parameters.

The feedback module operates in conjunction with the training module to retrain machine learning models based on feedback data. The feedback module selects relevant feedback data for inclusion in training datasets, ensuring that machine learning models are updated to reflect real-world usage scenarios and evolving claim processing requirements. The feedback module dynamically adjusts training priorities based on the volume and significance of feedback data, enabling targeted improvements to specific components of the digital claim remediation service.

The feedback module supports integration with graphical user interfaces to provide users with visibility into the feedback collection and application process. The graphical user interface associated with the feedback module displays summaries of feedback data, including categorized user inputs, system-generated corrections, and performance improvement metrics. The graphical user interface enables users to review, approve, or override feedback data, ensuring that the feedback module incorporates accurate and relevant information into the continuous improvement mechanism.

The feedback module includes configurable parameters that allow users to define thresholds, weighting factors, and validation rules for feedback data. Configurable parameters ensure that the feedback module aligns with organizational policies and operational goals. For example, the feedback module may prioritize feedback data associated with high-confidence claims or significant performance deviations.

The feedback module operates within the distributed computing network to process large volumes of feedback data efficiently. The distributed computing network enables the feedback module to parallelize feedback processing tasks, such as categorization, validation, and integration, across multiple nodes. The feedback module leverages the distributed computing network to ensure scalability and responsiveness in managing feedback data.

The feedback module enhances the adaptability, reliability, and transparency of the digital claim remediation service by providing a structured mechanism for continuous improvement. The feedback module ensures that machine learning models and operational components remain aligned with user needs and industry standards, contributing to the overall effectiveness and efficiency of the digital claim remediation service.

To further enhance usability, the method provides a graphical user interface (GUI) that allows users to configure machine learning models, adjust execution frequencies, and fine-tune confidence thresholds. For example, users can employ a dynamic slider to customize confidence levels that determine the degree of automation applied during claim processing. That is, via an interactive GUI, a user may interact with one or more GUI objects, such as a slider, input box, and/or the like to set confidence threshold, which may affect a technical speed at which defective digital claim data may be processed. In a non-limiting example, resetting a confidence threshold of the system to a reduced level may allow more potentially defective digital claims to be processed quickly via the automated digital claim data processing systems. This fine-grained control of the digital claim data processing throughput may enable an accelerated processing of digital claims in the case of larger volumes of adverse digital claim data being received into the system thereby reducing the amount of computer memory required for storing large volumes of digital claim data in the one or more databases of the system (e.g., system 100) and thereby further preserving computing resources. This level of configurability ensures that the system can be tailored to meet the specific needs of different users or organizations.

In summary, the disclosed method provides one or more robust technical solutions to the challenges of digital defective claim processing by automating defect identification, remediation, and routing. It addresses scalability, accuracy, and usability concerns through the integration of advanced machine learning techniques, distributed computing, and user-configurable interfaces. These technical improvements significantly enhance the efficiency and reliability of digital claim processing systems, offering tangible benefits in real-world applications.

### 2.05 Configuring a Digital Claim Denial/Defect Prediction Machine Learning Model

S205, which includes configuring a claim denial or claim defect prediction machine learning model, may function to configure a claim denial prediction machine learning model using any suitable machine learning model training and test platform. A claim denial prediction machine learning model, as generally referred to herein, may be used to predict a likelihood of denial of a draft digital claim before the draft digital claim may be submitted to a target entity (i.e., insurance company, healthcare payer, and/or the like). It shall be recognized that the “claim denial prediction machine learning model” may be interchangeably referred to herein as a “digital artifact defect prediction machine learning model”, “denial prediction machine learning model”, a “denial prediction classification model”, and/or the like.

In one or more embodiments, S205 may function to configure a claim denial prediction machine learning model based on a training of a machine learning classification model using one or more training corpora of adjudicated digital claims. In such embodiments, each training data sample of the one or more training corpora of adjudicated digital claims may include a distinct digital claim and a corresponding adjudication classification label. For instance, in a non-limiting example, a training data sample of one of the one or more training corpora of adjudicated digital claims may include a distinct digital claim that has been annotated with a corresponding adjudication outcome, such as, denied or the like. Additionally, or alternatively, a training data sample of one of the one or more training corpora of adjudicated digital claims may include a distinct digital claim that has been annotated with a corresponding adjudication outcome, such as, accepted or the like.

In one or more embodiments, the claim denial prediction machine learning model, once trained, may be invoked to predict a likelihood of denial for a target draft digital claim (i.e., a recently prepared digital claim) before it may be transmitted (or submitted) to a target insurance provider. In other words, a system or service implementing method 200 may use the claim denial prediction machine learning model to proactively identify draft digital claims that are likely to be denied and, in turn, preemptively fix the draft digital claims before submitting to a target insurance provider. Accordingly, this proactive measure may lead to a reduction in the number of claim denials experienced by a subscriber and lessen the subsequent appeals that would be necessitated.

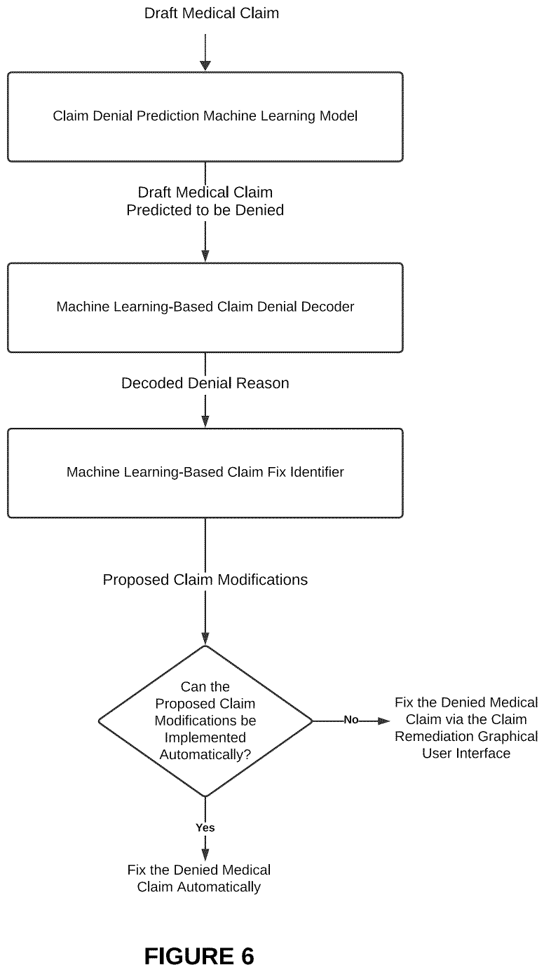

For instance, as shown generally by way of example in FIG. 6, a system or service implementing method 200 may function to receive a request to assess a draft digital claim (e.g., non-submitted digital claim). In one or more embodiments, based on receiving the request, the system or service may function to route the draft digital claim to the claim denial prediction machine learning model that, in turn, may predict that the draft digital claim may be likely to be denied by a healthcare payer. Furthermore, based on predicting that the draft digital claim may be likely to be denied, the system or service may function to use the machine learning-based claim denial decoder and the machine learning-based claim fix identifier to generate a decoded denial reason and one or more proposed claim modifications, respectively. Accordingly, based on the decoded denial reason and the one or more proposed claim modifications, the system or service may function to preemptively fix or adapt the draft digital claim and, in turn, submit the adapted digital claim to an appropriate insurance provider or healthcare payer.

Additionally, or alternatively, the digital claim defect prediction machine learning model, executed by one or more processors, may be configured to analyze defect feature data extracted from adverse digital claim data and compute one or more digital claim defect inferences. Each digital claim defect inference comprises a likely digital claim defect type and a confidence value associated with the likely digital claim defect type. The digital claim defect prediction machine learning model utilizes supervised learning techniques trained on historical claim data annotated with known defect types and resolutions. The training process ensures that the digital claim defect prediction machine learning model accurately identifies potential defect types within a variety of claim scenarios.

The digital claim defect prediction machine learning model applies advanced feature transformation techniques to process the defect feature data, including vectorization of structured and unstructured data fields and application of normalization algorithms to ensure consistency across input datasets. The digital claim defect prediction machine learning model processes the transformed defect feature data through one or more neural network layers to detect patterns indicative of specific defect types. For example, the digital claim defect prediction machine learning model may identify defect types such as missing required data fields, mismatched classification codes, or invalid numerical values.

The confidence value computed by the digital claim defect prediction machine learning model quantifies the likelihood that a given defect type may be present in the adverse digital claim data. The confidence value may be generated using probabilistic algorithms integrated within the machine learning framework. The digital claim defect prediction machine learning model outputs both the likely digital claim defect type and the confidence value as part of each defect inference. The output serves as input to a routing decision module for further evaluation.

The digital claim defect prediction machine learning model may be further configured to dynamically update prediction parameters based on new training data and feedback received from user interventions or resolved claims. The dynamic update mechanism ensures that the digital claim defect prediction machine learning model maintains high accuracy and adaptability as patterns in adverse digital claim data evolve over time.

The digital claim defect prediction machine learning model operates in conjunction with the distributed computing network to ensure scalability and efficiency. The distributed computing network facilitates parallel processing of multiple adverse digital claim datasets, enabling the digital claim defect prediction machine learning model to handle large volumes of claim data in real-time or near real-time. The digital claim defect prediction machine learning model supports customizable configurations, including adjustable confidence thresholds, which allow for fine-tuning the level of sensitivity in detecting defect types. Customizable configurations enable adaptation to different industry requirements or data processing environments.

### 2.1 Obtaining Denied Digital Claims

S210, which includes obtaining an adverse digital claim, may function to obtain or retrieve an adverse digital claim from any one of a plurality of distinct digital claim data sources. In one or more embodiments, a system or service implementing method 200 may obtain a subject denied digital claim and, in turn, use one or more machine learning models to identify a likely denial reason associated with the subject denied digital claim and, optionally, propose a set of corrective actions that, when implemented, likely converts the adverse digital claim to an approved claim. It shall be recognized that the phrase “denied digital claim” may be interchangeably referred to herein as a “denied claim”, an “anomalous digital claim”, an “adverse digital claim”, and/or the like without departing from the scope of the disclosure.

In one or more embodiments, an adverse digital claim may be a digital claim that has been denied or rejected by a target entity responsible for satisfying or not satisfying requests of the digital claim based on a determination that the digital claim fails to comply with one or more claim processing procedures and satisfaction parameters of the target entity. Additionally, or alternatively, in some embodiments, an adverse digital claim may be a digital claim that may be predicted, via the denial prediction machine learning model or the like, to be denied prior to the digital claim being submitted to a target entity. In other words, an adverse digital may be a digital claim that has already been rejected by a target entity (e.g., an insurance provider, a healthcare payer, etc.) or it may be a digital claim that, in its current form, may be predicted to be likely denied by the target entity.

In one or more embodiments, S210 may function to obtain an adverse digital claim for downstream claim assessment and processing based on receiving a request from a user to evaluate the adverse digital claim. For instance, in a non-limiting example, a system or service implementing method 200 may function to display, via a graphical user interface, a plurality of denied digital claims. The graphical user interface, in one or more embodiments, may enable a user, an analyst, and/or the like to select a target one of the plurality of denied digital claims for downstream claim assessment and remediation, as described in more detail herein.

Additionally, or alternatively, in one or more embodiments, S210 may function to obtain an adverse digital claim for downstream claim processing based on identifying an adverse digital claim that may be inbound to a system or service implementing method 200. In such embodiments, the system or service implementing method 200 may monitor incoming data streams for instances of denied digital claims. Accordingly, upon detecting an adverse digital claim, the system or service may function to automatically tag or flag the adverse digital claim for downstream claim processing and automatically initiate one or more automated adverse digital claim remediation processes for remediating defects of the denied digital claim.

### 2.2 Computing Denial Rationale Inferences

S220, which includes computing a denial rationale inference, may function to compute or generate a distinct denial rationale inference for each distinct denied digital claim obtained by S210. A denial rationale inference, as generally referred to herein, may include a denial type or denial reason that provides an intelligent explanation for why a target entity, such as an insurance provider or healthcare payer, denied or would likely deny a subject digital claim. In other words, a denial rationale inference computed for a subject denied digital claim may include an explainable interpretation of the likely factors leading to the subject denied digital claim to be denied or likely denied by the target entity.

### Configuring a Machine Learning-based Claim Denial Decoder

In one or more embodiments, S220 may function to configure a machine learning-based claim denial decoder based on a training of a target machine learning model using one or more corpora of historical digital claims. The machine learning-based claim denial decoder, when trained, may function to receive an adverse digital claim, analyze the features of the adverse digital claim, and output an explainable rationale on why the adverse digital claim was denied. It shall be recognized that a denial reason typically provided by a healthcare payer or insurance provider when rejecting a digital claim, often comes from a predefined denial list and typically fails to provide sufficient detail or clarity to understand the actual cause of the claim denial, as described in more detail herein.

Accordingly, in such embodiments, the target machine learning model (e.g., a machine learning-based claim denial decoder or the like) may use a set of learned weights and biases (generated from the training) to accurately predict a likely denial type or reason for a target denied digital claim.

It shall be recognized that the machine learning-based claim denial decoder may be any suitable machine learning model. For instance, in one or more embodiments, the machine learning-based claim denial decoder may be a decision tree machine learning model. Alternatively, in one or more embodiments, the machine learning-based claim denial decoder may be a random forest machine learning model. Alternatively, in one or more embodiments, the machine learning-based claim denial decoder may be a supervised machine learning model. Alternatively, in one or more embodiments, the machine learning-based claim denial decoder may be an unsupervised machine learning model. Alternatively, in one or more embodiments, the machine learning-based claim denial decoder may be a semi-supervised machine learning model.

### Implementing the Machine Learning-based Claim Denial Decoder

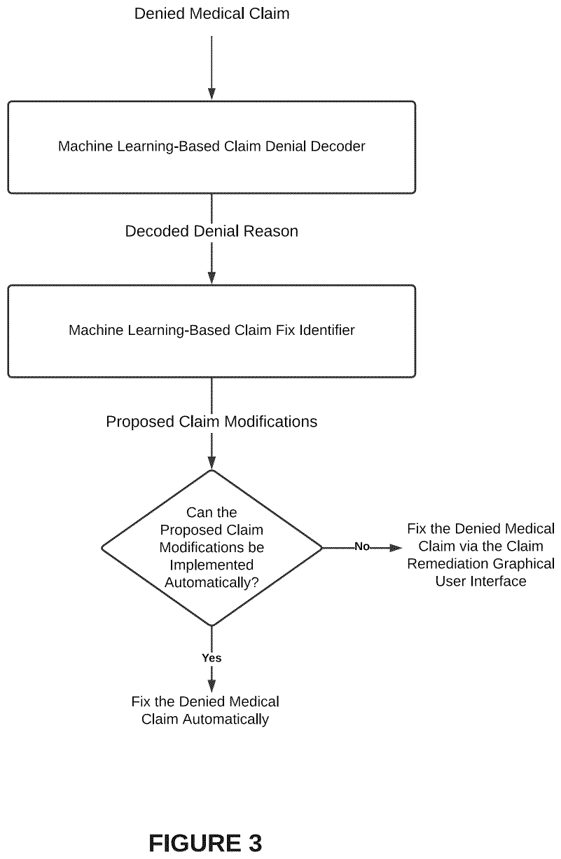

In one or more embodiments, the machine learning-based claim denial decoder may function to receive an adverse digital claim and output a machine learning-based inference that includes an explainable rationale that indicates one or more features or attributes in the claim that likely led to its denial by a subject insurance provider or healthcare payer, as shown generally by way of example in FIG. 3.

For instance, in a non-limiting example, S220 may function to receive an adverse digital claim. The adverse digital claim, in one or more embodiments, may include patient data (i.e., patient name, patient address, patient date of birth, patient gender, etc.), health insurance data (i.e., insurance plan, insurance level, payer identification, national provider identification, etc.), explanation of benefit data (i.e., payer data, claim identification data, charge amount, payment amount, facility data, denial reason data), and/or one or more charge lines specifying the procedures or services performed on the patient. It shall be recognized that each charge line may include a visit number, a location where the procedures or services were performed, a date of service, a procedure performed, a modifier associated with the procedure performed, a diagnosis code, and a charge amount.

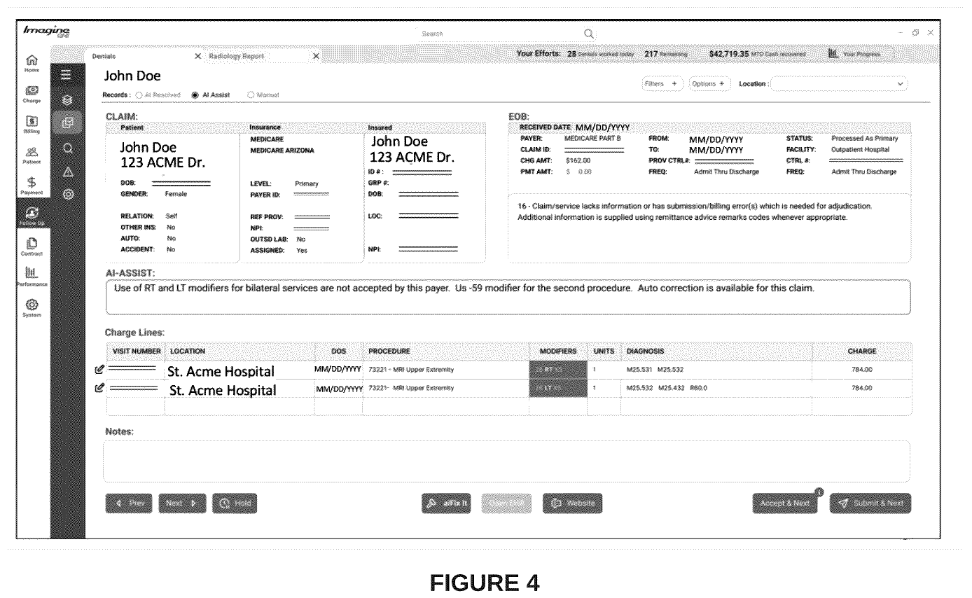

For instance, in such a non-limiting example, the adverse digital claim may include a first charge line that specifies the visit number (e.g., 1234567), a location that the services or procedures were performed (e.g., Location A), the date of service (e.g., Jun. 1, 2023), the procedure (e.g., 89023-MRI Upper Extremity), a modifier (e.g., 26 RT X5), a diagnosis (e.g., M25.531 M25.532), and a charge (e.g., $784.00), as shown generally by way of example in FIG. 4. Additionally, in such a non-limiting example, the adverse digital claim may include a second charge line that specifies the visit number (e.g., 1234567), a location that the services or procedures were performed (e.g., Location A), the date of service (e.g., Jun. 1, 2023), the procedure (e.g., 89023-MRI Upper Extremity), a modifier (e.g., 26 LT X5), a diagnosis (e.g., M25.532, M25.432, R60.0), and a charge (e.g., $784.00). Furthermore, in a such non-limiting example, the denial reason provided by the healthcare payer may be “16—Claim/service lacks information or has submission/billing error(s) which may be needed for adjudication. Additional information may be supplied using remittance advice remarks codes whenever appropriate”.

Accordingly, in one or more embodiments, S220 may function to extract a set of probative features from the adverse digital claim, provide the set of probative features, as input, to the machine learning-based claim denial decoder and, in turn, the machine learning-based claim denial decoder may output an inference that includes a decoded denial reason that may be a translation of the denial reason provided by the healthcare payer, such as, “use of RT and LT modifiers for bilateral services are not accepted by this payer”, as shown generally by way of example in FIG. 4.

Additionally, or alternatively, in another non-limiting example, S220 may function to receive an adverse digital claim. The adverse digital claim, in one or more embodiments, may include patient data (i.e., patient name, patient address, patient date of birth, patient gender, etc.), health insurance data (i.e., insurance plan, insurance level, payer identification, national provider identification, etc.), explanation of benefit data (i.e., payer data, claim identification data, charge amount, payment amount, facility data, denial reason data), and/or one or more charge lines specifying the procedures or services performed on the patient.

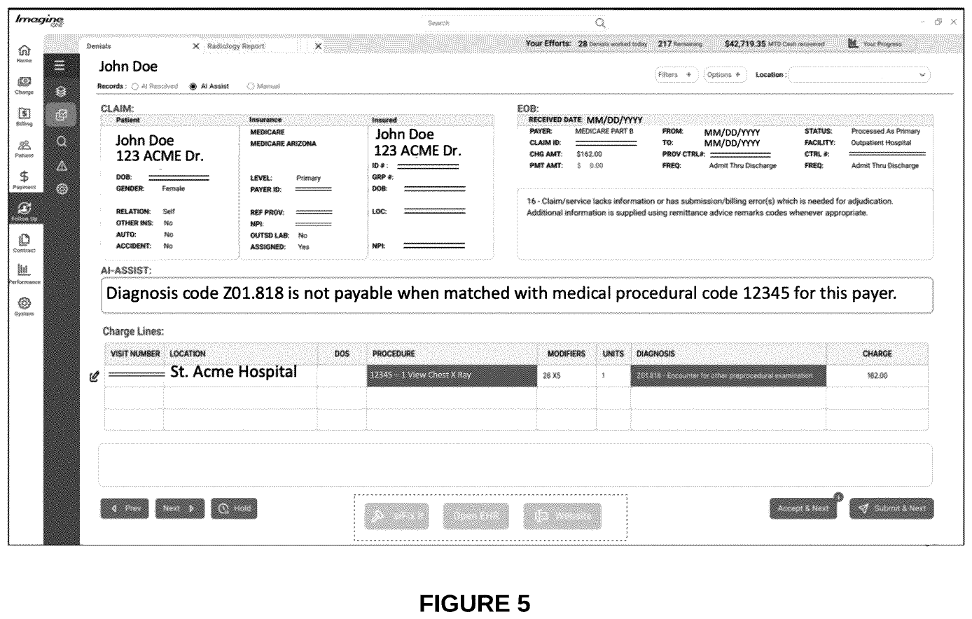

For instance, in such a non-limiting example, the adverse digital claim may include a first charge line that specifies the visit number (e.g., 9876543), a location that the services or procedures were performed (e.g., Location A), the date of service (e.g., Oct. 1, 2023), the procedure (e.g., 71046-1 View Chest X Ray), a modifier (e.g., 26 X5), a diagnosis (e.g., Z01.818—Encounter for other preprocedural examination), and a charge (e.g., $162.00), as shown generally by way of example in FIG. 5. Furthermore, in such a non-limiting example, the denial reason provided by the healthcare payer may be “16—Claim/service lacks information or has submission/billing error(s) which may be needed for adjudication. Additional information may be supplied using remittance advice remarks codes whenever appropriate”.

Accordingly, in one or more embodiments, S220 may function to extract a set of probative features from the adverse digital claim, provide the set of probative features, as input, to the machine learning-based claim denial decoder and, in turn, the machine learning-based claim denial decoder may output an inference that includes a decoded denial reason that may be a translation of the denial reason provided by the healthcare payer, such as, “Diagnosis code Z01.818 may be not payable when matched with medical procedural code 12345 for this payer”, as shown generally by way of example in FIG. 5.

Stated another way, in one or more embodiments, the machine learning-based claim denial decoder may function to generate an inference that includes a denial decoding or denial translation of (e.g., generic) claim denial data provided by a target entity (e.g., the payer or the like) for denying a subject adverse digital claim. The (e.g., generic) claim denial data provided by the target entity (e.g., the payer) for declining a subject adverse digital claim may not be clear, understandable, and/or usable. Thus, in one or more embodiments, the machine learning-based claim denial decoder may be capable of decoding or translating the (e.g., generic) claim denial data into explainable or understandable claim denial data.

### 2.3 Computing Claim Adaptation Inferences

S230, which includes computing claim adaptation inferences, may function to compute one or more claim adaptation inferences for each distinct denied digital claim obtained by S210. A claim adaptation inference, as generally referred to herein, may include one or more proposed claim modifications or adjustments to an adverse digital claim that, when implemented, increases a likelihood of converting the adverse digital claim to an approved (i.e., paid) digital claim upon resubmission. In other words, the one or more claim adaptation inferences computed for a subject denied digital claim may include proposed claim modification or proposed claim adjustments based on the denial rationale inference computed for the subject denied digital claim.

### Configuring a Machine Learning-Based Claim Fix Identifier

In one or more embodiments, S230 may function to configure a machine learning-based claim fix identifier based on a training of a target machine learning model using one or more corpora of denied-to-approved digital claim training data samples. In such embodiments, each denied-to-approved digital claim training data sample may include a training sample pairing between (i) an original digital claim that was submitted to a target entity and subsequently denied by the target entity and (ii) an adapted digital claim that may be a revised version of the original digital claim (i.e., has been adapted or modified in response to the denial from the target entity) and subsequently approved by the target entity. In other words, each digital claim training data sample represents a transition from an initial state of denial to a final state of approval.

It shall be noted that, in one or more embodiments, each training data sample of the one or more corpora of denied-to-approved digital claim training data samples may assist a target machine learning model with learning patterns and/or features that are indicative of the type of claim fixes that can convert a denied claim into an approved one.

### Implementing the Machine Learning-Based Claim Fix Identifier

In one or more embodiments, the machine learning-based claim fix identifier may function to receive, as input, an adverse digital claim and, optionally, a corresponding decoded denial reason. Accordingly, in one or more embodiments, based on receiving the input, the machine learning-based claim fix identifier may output a claim adaptation inference that includes one or more proposed claim modifications or adjustments that, when implemented, increases a likelihood of converting the adverse digital claim to an approved (i.e., paid) digital claim upon resubmission.

Stated another way, in one or more embodiments, based on or in response to computing a decoded denial reason for a subject denied digital claim, S230 may function route the decoded denial reason and the subject denied digital claim to the machine learning-based claim fix identifier. Accordingly, in such embodiments, the machine learning-based claim fix identifier may then output a claim adaptation inference that includes proposed claim modification or proposed claim adjustments that likely resolves or rectifies the claim denial.

For instance, with continuing reference to the above non-limiting example, the machine learning-based claim fix identifier may receive, as input, an adverse digital claim and/or a decoded denial reason associated with the adverse digital claim (e.g., “Use of RT and LT modifiers for bilateral services are not accepted by this payer”). Accordingly, in such a non-limiting example, the machine learning-based claim fix identifier may output a claim adaptation inference that indicates using a “−59” modifier for the second procedure instead of “LT”, as shown generally by way of example in FIG. 4.

It shall be noted that a system or service implementing method 200 may function to forego computing a claim adaptation inference for a subject denied digital claim when the decoded denial reason associated with the subject denied digital claim corresponds to a coding conflict between a diagnosis code and a medical procedural code (i.e., HCPCS, ICD-10 PCS, etc.). For instance, with continuing reference to the above non-limiting example, S230 may function to forego computing a claim adaptation inference for the adverse digital claim associated with a decoded denial code of “Diagnosis code Z01.818 may be not payable when matched with medical procedural code 12345 for this payer” as the decoded denial reason may be associated with a coding conflict between a diagnosis code (i.e., Z01.818) and a medical procedural code (i.e., medical procedural code 12345), as shown generally by way of example in FIG. 5.

### 2.4 Adapting an Adverse Digital Claim

S240, which includes adapting an adverse digital claim, may function to automatically or semi-automatically adapt a subject denied digital claim based on a claim adaptation inference computed for the subject denied digital claim. In one or more embodiments, S240 may function to adapt an adverse digital claim in a variety of modes including, but not limited to, semi-automatically via a claim remediation graphical user interface and/or automatically without user intervention, as described in more detail herein. It shall be recognized that “adapting an adverse digital claim” may also be interchangeably referred to herein as “fixing an adverse digital claim”, “modifying an adverse digital claim”, “amending an adverse digital claim”, and/or the like.

### Automatically Fixing an Adverse Digital Claim

In one or more embodiments, when a confidence score of a claim adaptation inference that corresponds to a subject denied digital claim satisfies a predetermined minimum adaptation confidence threshold, S240 may function to autonomously adapt the subject denied digital claim to an adapted digital claim based on the claim adaptation inference. That is, in such embodiments, S240 may function to automatically implement the proposed claim modifications to the subject denied digital claim without requiring manual input or oversight from a subscriber, a user, and/or the like.

It shall be recognized that, in one or more embodiments, S240 may use one or more robotic process automations (RPAs) to interact with one or more electronic health record (EHR) systems and/or any other relevant medical databases. This may enable S240 to autonomously retrieve probative pieces of data that may be needed to correct or amend a subject denied digital claim. Stated differently, a system or service implementing method 200 may use robotic process automations to systematically search for and collect pieces of data as specified by the claim adaptation inference and/or the decoded denial reason associated with the subject denied digital claim.

For instance, in a non-limiting example, if a subject digital claim was denied due to the absence of prior authorization data as indicated by a claim adaptation inference and/or a decoded denial reason associated with the subject digital claim, S240 may function to deploy one or more task automation scripts of a plurality of distinct task automation scripts to access a target electronic health record (EHR) and navigate, using the one or more task automation scripts, to a target patient record to retrieve the prior authorization data (i.e., a prior authorization number or the like). Accordingly, upon obtaining the prior authorization data, S240 may function to automatically adapt the subject digital claim to an adapted digital claim that includes the newly obtained prior authorization data.

Additionally, or alternatively, if the subject digital claim was denied due to missing a referring physician's national provider identifier (NPI), a provider national provider identifier (NPI), and/or the like, S240 may function to obtain and adapt the subject digital claim in analogous ways as described above. Additionally, or alternatively, if the subject digital claim was denied due to missing another piece of requisite information, S240 may function to obtain and adapt the subject digital claim in analogous ways as described above.

In another non-limiting example, a target digital claim may have been denied due to a payer's interpretation that one or more charge lines included within the target digital claim are duplicates as indicated by a decoded denial reason or a claim adaptation inference computed for the target digital claim. Specifically, in such a non-limiting example, the target digital claim may include a first change line associated with a magnetic resonance imaging (MRI) procedure code for a right, upper extremity with the modifiers “26 RT X5” and a second change line associated with a magnetic resonance imaging (MRI) procedure code for a left, upper extremity with the modifiers “26 LT X5”. In such a non-limiting example, a decoded denial reason computed for the target digital claim may be “Use of RT and LT modifiers for bilateral services are not accepted by this payer” and a claim adaptation inference computed for the target digital claim may be “Use −59 modifier for the second procedure”. In other words, via one or more machine learning models of the system or service implementing method 200, the system or service identified that the payer associated with the target digital claim requires the use of the “−59” modifier to indicate that the MRI procedures for each upper extremity are distinct and independent services.

Accordingly, the system or service implementing method 200, based on or in response to computing the decoded denial reason and/or the claim adaptation inference, may proceed to autonomously adapt the target digital claim by automatically identifying a location within the target digital claim associated with the second charge line and automatically adjusting the modifier component of the second charge line by replacing the “LT” modifier with the “59” modifier. In other words, the autonomous adaptation of the target digital claim may be informed by the machine learning models of the system or service, which have been trained on historical digital claim data to detect and resolve such claim deficiencies effectively.

### Semi-Automatically Fixing an Adverse Digital Claim

In one or more embodiments, when a confidence score of a claim adaptation inference that corresponds to a subject denied digital claim does not satisfy a predetermined minimum adaptation confidence threshold, S240 may function to forego autonomously adapting or modifying the subject denied digital claim. In one or more embodiments, S240 may function to display, via a claim remediation graphical user interface, a representation of an adverse digital claim.

For instance, in a non-limiting example, S240 may function to display, via the claim remediation graphical user interface, a representation of a target denied digital claim based on receiving a user input that corresponds to assessing or reviewing the target denied digital claim. The claim remediation graphical user interface, in one or more embodiments, may enable a user to efficiently identify and address each distinct element of the target denied digital claim that may require correction or further examination. Stated another way, in one or more embodiments, the claim remediation graphical user interface may be designed to display a plurality of distinct portions of the target denied digital claim, where each distinct portion corresponds to a distinct element of the target denied digital claim, enabling users to interactively engage and perform remediation tasks directly within the claim remediation graphical user interface.

Additionally, in one or more embodiments, the claim remediation graphical user interface may include an “AI-assist” section, as shown generally by way of example in FIG. 4 and FIG. 5. The “AI-Assist” section, in one or more embodiments, may include the decoded denial reason generated for the target denied digital claim and/or a set of corrective actions that, when implemented, likely converts the target denied digital claim to an approved claim.

Additionally, in one or more embodiments, the claim remediation graphical user interface may include a selectable user interface object (i.e., a button or the like) that, when selected, automatically performs one or more claim remediation actions in accordance with the “AI-Assist” section to adapt a subject denied digital claim to an adapted denied digital claim.

It shall be recognized that, in one or more embodiments, the claim remediation graphical user interface may utilize visual cues, such as color coding, icons, or other indicators, to draw the user's attention to the portions of the claim that the system or service implementing method 200 has identified as likely problematic, as shown generally by way of example in FIG. 4 and FIG. 5.

### 2.5 Electronically Filing an Adapted Digital claim

S250, which includes electronically filing an adapted digital claim may function to file or re-file a subject adapted digital claim with a target entity. In one or more embodiments, S250 may function to electronically file an adapted digital claim in a variety of modes including, but not limited to, semi-automatically via the claim remediation graphical user interface and/or automatically without user intervention, as described in more detail herein. It shall be recognized that, in one or more embodiments, electronically filing a subject adapted digital claim may include the submission (or resubmission) of an adverse digital claim that has been modified or corrected through any suitable electronic medium.

In one or more embodiments, S250 may function to automatically submit, file, and/or the like an adapted digital claim based on or in response to adapting a subject denied digital claim to the adapted digital claim. That is, in such embodiments, the system or service implementing method 200 may be configured to initiate the filing (or submission) process immediately after the adaptation process may be completed, without the need for additional user commands or manual intervention.

In one or more embodiments, using the claim remediation graphical user interface, S250 may function to electronically file an adapted digital claim based on receiving an input selecting a claim filing button (i.e., submit and next button), as shown generally by way of example in FIG. 4 and FIG. 5. Stated another way, in one or more embodiments, the ‘Submit and Next’ button of the claim remediation graphical user interface, when selected, prompts the system or service implementing method 200 to engage in the electronic submission of the adapted digital claim.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component may be preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition may be satisfied, and a second step if the condition may not be satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that may be repeated until each of the conditions described in the method has been met. This, however, may not be required of system or computer readable medium claims where the system or computer readable medium contains instructions for performing the contingent operations based on the satisfaction of the corresponding one or more conditions and thus may be capable of determining whether the contingency has or has not been satisfied without explicitly repeating steps of a method until all of the conditions upon which steps in the method are contingent have been met. A person having ordinary skill in the art would also understand that similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

1. The computer-implemented method according to claim 21, further comprising:
receiving, via the distributed network of computers, adverse digital claim data comprising a plurality of data fields, wherein at least one data field of the plurality of data fields includes data contributing to a cause of an adverse action against a target digital claim;
extracting defect feature data from at least one or more of the plurality of data fields of the adverse digital claim data;
computing, using the first supervised machine learning model, one or more first inferences based on an input of at least the defect feature data, wherein each of the one or more first inferences includes:
a likely digital claim defect type, and
a confidence value for the likely digital claim defect type;
automatically evaluating the likely digital claim defect type and the confidence value of the one or more first inferences against predefined digital claim routing criteria stored in memory, wherein:
when one or more of the likely digital claim defect type and the confidence value of the one or more first inferences satisfies the predefined digital claim routing criteria, the computer-implemented method automatically routes the adverse digital claim data to an automated claim remediation module or queue; and
when one or more of the likely digital claim defect type and the confidence value of the one or more first inferences fails to satisfy the predefined digital claim routing criteria, the computer-implemented method automatically routes the adverse digital claim data to an automated claim disposal module or queue.

2. The computer-implemented method according to claim 1, further comprising:
executing, by the distributed network of computers, the second supervised machine learning model that generates one or more second inferences for correcting one or more defects associated with the target digital claim based on an input of the one or more first inferences, wherein each of the one or more second inferences includes:
a target digital claim parameter requiring correction in the target digital claim, and
a likely parameter value for establishing the correction in the target digital claim.

3. The computer-implemented method according to claim 2, further comprising:
adapting the target digital claim by automatically applying the likely parameter value to the target digital claim parameter associated with each of the one or more second inferences, wherein the application of the likely parameter value either:
replaces a pre-existing defective parameter value, or
fills one or more parameter fields that were missing a given parameter value, thereby constructing a defect-free digital claim.

4. The computer-implemented method according to claim 21, further comprising:
at a remote digital claim remediation service being executed by the distributed network of computers:
receiving, via a computing network, adverse digital claim data comprising a plurality of data fields, wherein at least one data field of the plurality of data fields includes data contributing to a cause of an adverse action against a target digital claim;
extracting, by a feature extraction model, defect feature data from at least one or more of the plurality of data fields of the adverse digital claim data;
computing, by one or more computer processors executing the first supervised machine learning model, one or more digital claim defect inferences based on an input of at least the defect feature data, wherein each of the one or more digital claim defect inferences includes:
(a) a likely digital claim defect type, and
(b) a confidence value for the likely digital claim defect type;
automatically evaluating, by the one or more computer processors, of the likely digital claim defect type and the confidence value of the one or more digital claim defect inferences against predefined digital claim routing criteria, wherein:
when one or more of the likely digital claim defect type and the confidence value of the one or more digital claim defect inferences satisfies the predefined digital claim routing criteria stored in memory, automatically routing by the one or more computer processors the adverse digital claim data to an automated claim remediation module or queue for automatically remediating one or more defects of the target digital claim and causing an automated resubmission, in real-time or near real-time, of a defect-free digital claim thereby accelerating a processing of the adverse digital claim data, or
when one or more of the likely digital claim defect type and the confidence value fails to satisfy the predefined digital claim routing criteria, automatically routing by the one or more computer processors the adverse digital claim data to an automated claim disposal module or queue for automatically blocking a resubmission of the target digital claim or a variation of the target digital claim thereby preserving computational resources of the remote digital claim remediation service.

5. The computer-implemented method according to claim 4, wherein automatically remediating the one or more defects of the target digital claim includes:
automatically generating, by the one or more computer processors executing the second supervised machine learning model, one or more digital claim remediation inferences for correcting the one or more defects of the target digital claim based on an input of the one or more digital claim defect inferences, wherein the one or more digital claim remediation inferences include a target digital claim parameter for correction in the target digital claim and a likely parameter value for establishing the correction in the target digital claim.

6. The computer-implemented method according to claim 5, wherein automatically remediating the one or more defects of the target digital claim further includes:
adapting the target digital claim based on automatically applying, by the one or more computer processors, the likely parameter value to the target digital claim parameter, wherein the application of the likely parameter value either replaces a pre-existing defective parameter value or fills one or more of a plurality of parameter fields that was missing a given parameter value thereby constructing the defect-free digital claim.

7. The computer-implemented method according to claim 5, wherein automatically remediating the one or more defects of the target digital claim further includes:
adapting the target digital claim based on automatically encoding, by the one or more computer processors, the likely parameter value to the target digital claim parameter, wherein the encoding of the likely parameter value either replaces a pre-existing defective parameter value or fills one or more of a plurality of parameter fields that was missing a given parameter value thereby constructing the defect-free digital claim.

8. The computer-implemented method according to claim 4, further comprising:
generating, by the one or more computer processors executing a machine learning-based adverse claim decoder, one or more adverse action rationales comprising an explanation of a reason for the adverse action against the target digital claim.

9. The computer-implemented method according to claim 8, wherein automatically routing by the one or more computer processors the adverse digital claim data to the automated claim disposal module or queue includes:
digitally associating the one or more adverse rationales to the adverse digital claim data, and
surfacing, via a graphical user interface, the adverse digital claim data and the one or more adverse rationales based on a selection of the adverse digital claim data from the automated claim disposal module or queue.

10. The computer-implemented method according to claim 4, wherein the predefined digital claim routing criteria include at least:
a minimum confidence threshold value, and
a classification of the defect type as remediable or non-remediable.

11. (canceled)

12. (canceled)

13. The computer-implemented method according to claim 4, wherein automatically evaluating the likely digital claim defect type and the confidence value of the one or more digital claim defect inferences further includes:
dynamically updating, by the one or more computer processors, the predefined digital claim routing criteria based on performance metrics of previously remediated digital claims.

14. The computer-implemented method according to claim 4, further comprising:
generating, by the one or more computer processors, a visual representation of the (i) likely digital claim defect type and the confidence value associated with the one or more digital claim defect inferences and (ii) the predefined routing criteria via a graphical user interface to enable manual intervention for claims requiring human review.

15. (canceled)

16. (canceled)

17. The computer-implemented method according to claim 7, wherein in response to constructing the defect-free digital claim:
automatically routing the defect-free digital claim to a resubmission or a submission portal, and
automatically resubmitting the defect-free digital claim via the resubmission or the submission portal.

18. (canceled)

19. The computer-implemented method according to claim 21, further comprising:
at a remote digital claim remediation service being executed by a distributed network of computers:
receiving, via a computing network, adverse digital claim data comprising a plurality of data fields, wherein at least one data field of the plurality of data fields includes data contributing to a cause of an adverse action against a target digital claim;
extracting, by a feature extraction model, defect feature data from at least one or more of the plurality of data fields of the adverse digital claim data;
computing, by one or more computer processors executing the first supervised machine learning model, one or more first inferences based on an input of at least the defect feature data, wherein each of the one or more first inferences includes:
(a) a likely digital claim defect type, and
(b) a confidence value for the likely digital claim defect type;
automatically evaluating, by the one or more computer processors, the likely digital claim defect type and the confidence value of the one or more first inferences against predefined digital claim routing criteria;
automatically generating, by the one or more computer processors executing the second supervised machine learning model, one or more second inferences for correcting one or more defects of the target digital claim based on an input of the one or more first inferences, wherein the one or more second inferences include a target digital claim parameter for correction in the target digital claim and a likely parameter value for establishing the correction in the target digital claim;
adapting the target digital claim based on automatically applying, by the one or more computer processors, the likely parameter value to the target digital claim parameter, wherein the application of the likely parameter value either replaces a pre-existing defective parameter value or fills one or more of a plurality of parameter fields that was missing a given parameter value thereby constructing a defect-free digital claim; and
causing an automated resubmission, in real-time or near real-time, of the defect-free digital claim thereby accelerating a processing of the adverse digital claim data.

20. The computer-implemented method according to claim 19, further comprising:
generating, by the one or more computer processors executing a machine learning-based adverse claim decoder, one or more adverse action rationales comprising an explanation of a reason for an adverse action against the target digital claim.

21. A computer-implemented method comprising:
obtaining, using a distributed network of computers, a first annotated training dataset, wherein each training data sample included in the first annotated training dataset includes a distinct digital claim and a corresponding claim adjudication classification label;
training a machine learning classification model using the first annotated training dataset;
obtaining, using the distributed network of computers, a second annotated training dataset comprising historical digital claim data annotated with corresponding defect types and remediation outcomes;
training a first supervised machine learning model using the second annotated training dataset;
obtaining, using the distributed network of computers, a third annotated training dataset comprising denied-to-approved digital claim training data samples, wherein:
each denied-to-approved digital claim training data sample included in the third annotated training dataset includes a training sample pairing comprising an original digital claim that was denied by a target entity and an adapted version of the original digital claim that was approved by the target entity; and
training a second supervised machine learning model using the third annotated training dataset.

22. The computer-implemented method according to claim 21, wherein:
the first supervised machine learning model corresponds to a first neural network, and
the second supervised machine learning model corresponds to a second neural network.

23. The computer-implemented method according to claim 21, wherein:
the first supervised machine learning model corresponds to a random forest machine learning model, and
the second supervised machine learning model corresponds to a neural network.

24. A computer-implemented method comprising:
at a remote digital item remediation service being executed by a distributed network of computers:
receiving, via a computing network, adverse digital data comprising a plurality of data fields, wherein at least one data field of the plurality of data fields includes data contributing to a cause of an adverse action against a target digital item;
extracting, by a feature extraction model, defect feature data from at least one or more of the plurality of data fields of the adverse digital data;
computing, by one or more computer processors executing a first supervised machine learning model, an inference based on an input of at least the defect feature data, wherein the inference includes:
(a) a likely defect type, and
(b) a confidence value for the likely defect type;
automatically evaluating, by the one or more computer processors, the likely defect type and the confidence value against predefined routing criteria, wherein:
when the likely defect type and the confidence value satisfies the predefined routing criteria stored in memory, automatically routing by the one or more computer processors the adverse digital data to an automated remediation module or queue for automatically remediating one or more defects of the target digital item and causing an automated resubmission, in real-time or near real-time, of a defect-free digital item thereby accelerating a processing of the adverse digital data, or
when the likely defect type and the confidence value fails to satisfy the predefined routing criteria, automatically routing by the one or more computer processors the adverse digital data to an automated disposal module or queue for automatically blocking a resubmission of the target digital item or a variation of the target digital item thereby preserving computational resources of the remote digital item remediation service.

25. A computer-implemented method comprising:
at a remote digital item remediation service being executed by a distributed network of computers:
receiving, via a computing network, adverse data comprising a plurality of data fields, wherein at least one data field of the plurality of data fields includes data contributing to a cause of an adverse action against a target digital item;
extracting, by a feature extraction model, defect feature data from at least one or more of the plurality of data fields of the adverse data;
computing, by one or more computer processors executing a first neural network, a first inference based on an input of at least the defect feature data, wherein the first inferences includes:
(a) a likely digital defect type, and
(b) a confidence value for the likely digital defect type;
automatically evaluating, by the one or more computer processors, the likely digital defect type and the confidence value against predefined routing criteria;
automatically generating, by the one or more computer processors executing a second neural network, a second inference for correcting one or more defects of the target digital item based on an input of the first inference, wherein the second inference includes a target digital parameter for correction in the target digital item and a likely parameter value for establishing the correction in the target digital item;
adapting the target digital item based on automatically applying, by the one or more computer processors, the likely parameter value to the target digital parameter, wherein the application of the likely parameter value either replaces a pre-existing defective parameter value or fills one or more of a plurality of parameter fields that was missing a given parameter value thereby constructing a defect-free digital item; and
causing an automated resubmission, in real-time or near real-time, of the defect-free digital item thereby accelerating a processing of the adverse data.
